(19) United States
(12) Patent Application Publication
(10) Pub. No.: US 2012/0316779 A1
(43) Pub. Date: Dec. 13, 2012

(54) DRIVING ASSISTANCE DEVICE

(75) Inventors: Yukiko Kanno, Kanagawa (JP); Tatsuto Ryugo, Tokyo (JP); Kenji Okano, Kanagawa (JP); Masayoshi Michiguchi, Kanagawa (JP)

(73) Assignee: PANASONIC CORPORATION, Osaka (JP)

(21) Appl. No.: 13/581,158

(22) PCT Filed: Feb. 25, 2011
(86) PCT No.: PCT/JP2011/001120

§ 371 Date: Aug. 24, 2012

(30) Foreign Application Priority Data
Feb. 26, 2010 (JP) 2010-041858

(51) Int. Cl. G01C 21/36

(52) U.S. Cl. 701/436

(57) ABSTRACT

Provided is a driving assistance device which enables a driver to intuitively determine the relationship between the upper boundary line and the lower boundary line of an anticipated trajectory of travel that is displayed in three dimensions. The driving assistance device is provided with: an image processing device (3) that superimposes a three-dimensional anticipated trajectory of travel (30) of a vehicle, which is read off from a non-volatile memory (4), onto an image captured outside of the vehicle inputted from a capture device (7), and outputs the result to an external display device (12); and a control device (5) which controls the orientation of the three-dimensional anticipated trajectory of travel (30) that is superimposed by the image processing device (3) on the basis of a steering angle signal inputted from a steering sensor (10).

### TECHNICAL FIELD

The present invention relates to a driving assistance apparatus for guiding the traveling direction of a vehicle by a trajectory when the vehicle is parked.

### BACKGROUND ART

A conventional driving assistance apparatus has been known which three-dimensionally displays a predicted traveling trajectory of a vehicle to detect an obstacle in the height direction on the predicted traveling trajectory of the vehicle (for example, see Patent Literatures 1 and 2).

### CITATION LIST

### Patent Literatures

PTL 1 Japanese Patent Application Laid-Open No. 2001-010428
PTL 2 Japanese Patent Application Laid-Open No. 2003-063340

### SUMMARY OF INVENTION

### Technical Problem

As for the predicted traveling trajectory which is three-dimensionally displayed in the conventional driving assistance apparatus, however, a lower frame line defining the plane on the bottom face side and an upper frame line defining the plane on the top face side are displayed in similar shapes in the neighborhood of each other. For this reason, it is difficult for a user to recognize the relationship between the three-dimensionally displayed predicted traveling trajectory and a two-dimensionally displayed background image.

Accordingly, it is difficult for the user to intuitively determine whether the relationship between the lower frame line and upper frame line in the three-dimensionally displayed predicted traveling trajectory represents a relationship with some margin, a three dimensional relationship viewed upward from a road surface (above the ground) or a three dimensional relationship viewed downward from the road surface (below the ground).

The present invention has been made to solve the conventional problem and aims to provide a driving assistance apparatus making it possible to intuitively determine the relationship between the lower frame line and upper frame line in the predicted traveling trajectory which is three-dimensionally displayed.

### Solution to Problem

To achieve the above described object, a control section of the present invention causes a video processing section to gradually change the density of color of a three-dimensional side face of a predicted traveling trajectory upward in the height direction.

### ADVANTAGEOUS EFFECT OF INVENTION

The present invention thus brings about an advantageous effect that a user can intuitively determine the relationship between the lower frame line and upper frame line of a predicted traveling trajectory which is three-dimensionally displayed.

### BRIEF DESCRIPTION OF DRAWINGS

FIG. 1 is a block diagram showing the configuration of a driving assistance apparatus in an embodiment of the present invention;

FIG. 2 is a flowchart of a driving assistance process by a control device which is a main section in FIG. 1;

FIG. 3 is a diagram illustrating a representation of a three-dimensional predicted traveling trajectory stored in a nonvolatile memory which is a main section in FIG. 1;

FIG. 4 is a diagram illustrating a representation of change in the density of color of the predicted traveling trajectory with time in FIG. 3;

FIG. 5 is a diagram illustrating a representation of an image further superimposed on the predicted traveling trajectory in FIG. 3; and

FIG. 6 is a diagram illustrating a representation of another example of the superimposed image in FIG. 5.

### DESCRIPTION OF EMBODIMENT

A driving assistance apparatus of an embodiment of the present invention will be described below with reference to the drawings.

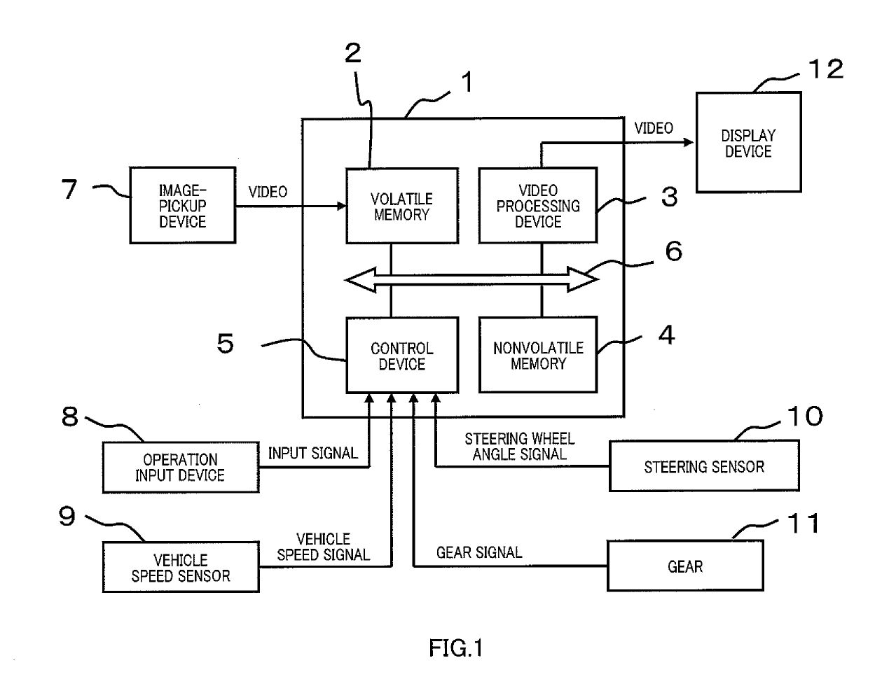

FIG. 1 is a block diagram showing the configuration of the driving assistance apparatus of the embodiment of the present invention.

In FIG. 1, driving assistance apparatus 1 has volatile memory 2, video processing device 3, nonvolatile memory 4, control device 5 and bus 6 connecting these components with one another. Driving assistance apparatus 1 is connected with image-pickup device 7, operation input device 8, vehicle speed sensor 9, steering sensor 10, gear 11 and display device 12. Image-pickup device 7, operation input device 8, vehicle speed sensor 9, steering sensor 10, gear 11 and display device 12 may be included in driving assistance apparatus 1.

Volatile memory 2 includes, for example, a video memory or a RAM (Random Access Memory). Volatile memory 2 is connected with image-pickup device 7. Volatile memory 2 temporarily stores video data obtained from a taken image input from image-pickup device 7 at each predetermined time interval. The video data stored in volatile memory 2 is output to video processing device 3 via bus 6.

Video processing device 3 includes, for example, an ASIC (Application Specific Integrated Circuit) or VLSI (Very Large Scale Integration). Video processing device 3 is connected with display device 12. Video processing device 3 creates a composite image at each predetermined time interval, the image being obtained by superimposing image data input from nonvolatile memory 4 on the video data input from volatile memory 2. Video processing device 3 outputs the composite image created at each predetermined time interval to display device 12 as video.

Nonvolatile memory 4 includes, for example, a flash memory or a ROM (Read Only Memory). Nonvolatile memory 4 stores various kinds of image data such as image data of the vehicle and image data of a three-dimensional predicted traveling trajectory of the vehicle. The image data stored in nonvolatile memory 4 is read in accordance with an instruction of control device 5 and image-processed by video processing device 3.

The control device 5 includes, for example, a CPU (Central Processing Unit) or an LSI (Large Scale Integration). Control device 5 is connected with operation input device 8, vehicle speed sensor 9, steering sensor 10 and gear 11. Control device 5 controls video processing device 3 for video processing, data to be read from volatile memory 2 or nonvolatile memory 4, inputs from image-pickup device 7, outputs to display device 12 and the like, on the basis of various signals input from operation input device 8, vehicle speed sensor 9, steering sensor 10 and gear 11. For example, control device 5 reads image data of a three-dimensional predicted traveling trajectory of the vehicle from nonvolatile memory 4 on the basis of an input signal from steering sensor 10. Control device 5 causes video processing device 3 to create a composite image in which the image data of the three-dimensional predicted traveling trajectory of the vehicle is superimposed on video data input from volatile memory 2.

Image-pickup device 7 has at least one or more cameras. Image-pickup device 7 takes at least an image of the backward of the vehicle. Image-pickup device 7 may take an image of the front and images of right and left sides of the vehicle. Image-pickup device 7 may be installed at any position as long as an image of the outside of the vehicle can be taken at the position. Image-pickup device 7 inputs an image taken at each predetermined time interval to volatile memory 2 of driving assistance apparatus 1 as video.

Operation input device 8 includes, for example, a touch panel, a remote controller or a switch. When operation input device 8 is a touch panel, it may be provided on display device 12. Operation input device 8 outputs an input signal by a user's operation to control device 5. For example, operation input device 8 outputs an input signal of an instruction for switching video displayed on display device 12, to control device 5.

Vehicle speed sensor 9, steering sensor 10 and gear 11 output a vehicle speed signal indicative of the speed of the vehicle, a steering wheel angle signal indicative of a steering angle and a gear signal indicative of the state of a shift lever, respectively, to control device 5.

Display device 12 includes, for example, a navigation device or a rear-seat display.

Display device 12 displays video input from video processing device 3.

Next, a driving assistance process by control device 5 will be described.

In this embodiment, especially a driving assistance process for the backward of the vehicle will be described.

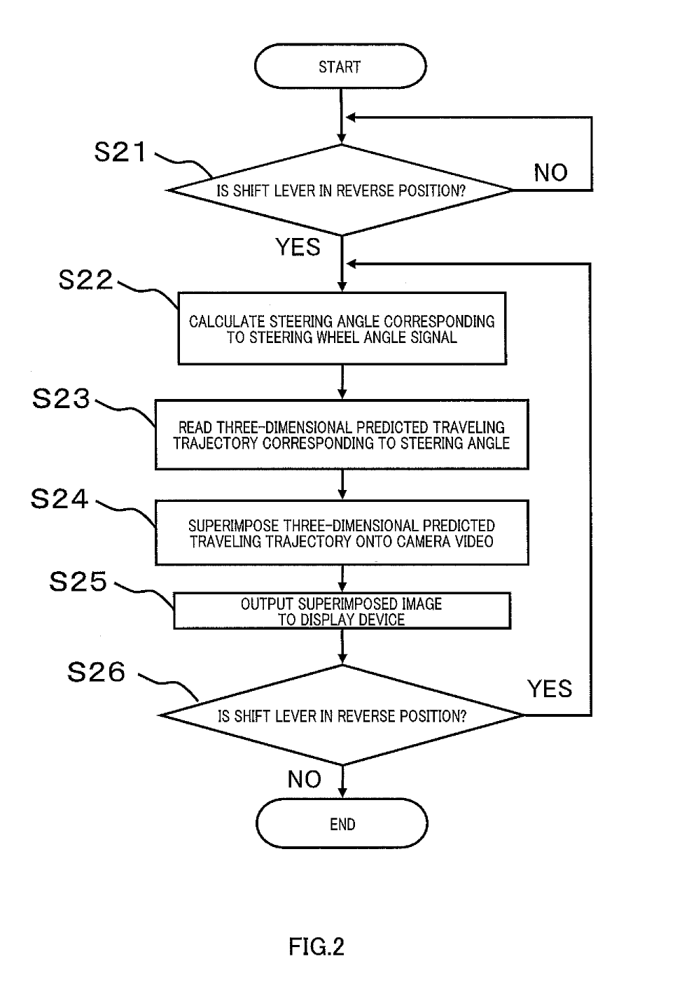

FIG. 2 is a flowchart of the driving assistance process by control device 5.

First, as shown in step S21, control device 5 determines whether the shift lever is in the reverse position or not on the basis of a gear signal input from gear 11.

In the case of NO at step S21, control device 5 performs the processing at step S21 again after a predetermined time period.

In the case of YES at step S21, control device 5 calculates a steering angle on the basis of a steering wheel angle signal input from steering sensor 10 as shown in step S22.

Next, as shown in step S23, control device 5 reads image data of a three-dimensional predicted traveling trajectory corresponding to the steering angle calculated at step S22 from nonvolatile memory 4.

Next, as shown in step S24, control device 5 reads the image data of the three-dimensional predicted traveling trajectory from nonvolatile memory 4, and video processing device 3 superimposes the image data of the predicted traveling trajectory read by control device 5, onto a taken image.

Next, as shown in step S25, control device 5 causes video processing device 3 to output the composite image obtained by the superimposition at step S24 to display device 12.

Then, as shown in step S26, control device 5 determines whether the shift lever is in the reverse position or not on the basis of a gear signal input from gear 11.

In the case of YES at step S26, control device 5 performs the processing at and after step S22 again. Thereby, display device 12 can display video of the backward of the vehicle on which the three-dimensional predicted traveling trajectory is superimposed.

In the case of NO at step S26, control device 5 determines that the user does not need the driving assistance process for the backward of the vehicle and ends the driving assistance process.

Next, the image data of the three-dimensional predicted traveling trajectory of the vehicle stored in nonvolatile memory 4 will be described.

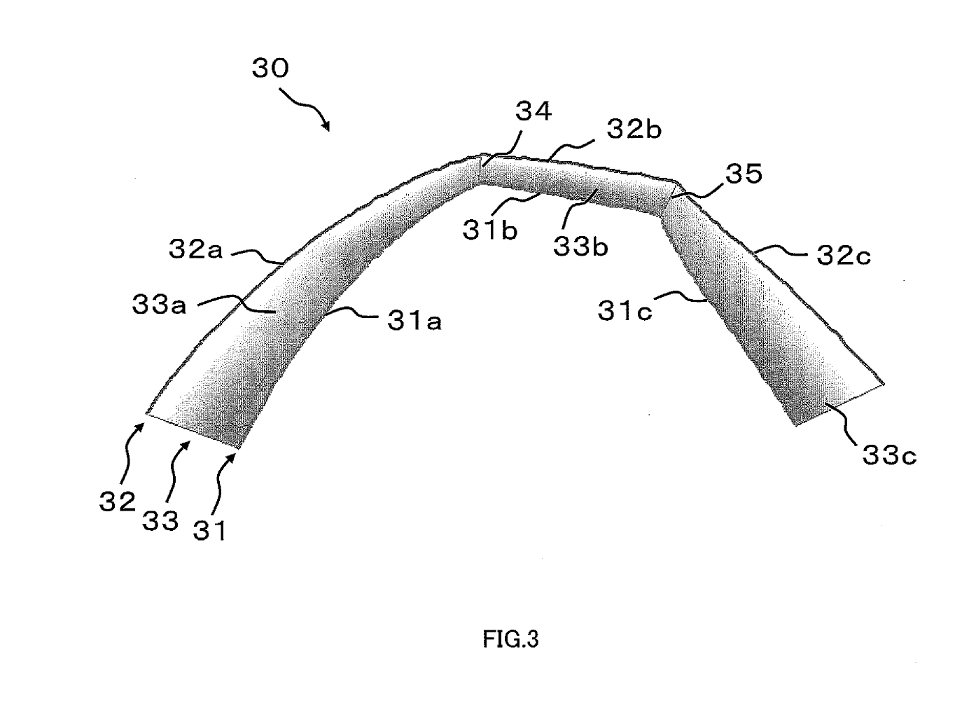

FIG. 3 is a diagram illustrating a representation of the three-dimensional predicted traveling trajectory stored in nonvolatile memory 4.

As shown in FIG. 3, three-dimensional predicted traveling trajectory 30 of the vehicle has three-dimensional side face 33 formed of square-bracket shaped first trajectory 31 (upper frame line) indicating the bottom face side of the three-dimensional trajectory, square-bracket shaped second trajectory 32 (lower frame line) indicating the top face side of the three-dimensional trajectory, and a space surrounded by first trajectory 31 and second trajectory 32. Predicted traveling trajectory 30 may further have first separation line 34 and second separation line 35 which separate this three-dimensional side face 33. The “right” and “left” used in the description below mean the “right” and “left” when the vehicle is seen from the traveling direction of the vehicle.

First trajectory 31 has first right-side trajectory 31a indicating a predicted traveling trajectory of the right side of the vehicle, first backward trajectory 31b indicating the predicted traveling trajectory of the rear-end of the vehicle and first left-side trajectory 31c indicating a predicted traveling trajectory of the left side of the vehicle. The position of first trajectory 31 in the height direction is on the ground. The positions of first right-side trajectory 31a and first left-side trajectory 31c in the vehicle width direction are located away from respective side mirrors of the vehicle by a predetermined distance relative to the center of the vehicle.

Second trajectory 32 has second right-side trajectory 32a indicating a predicted traveling trajectory of the right side of the vehicle, second backward trajectory 32b indicating a predicted traveling trajectory of the rear-end of the vehicle, and second left-side trajectory 32c indicating a predicted traveling trajectory of the left side of the vehicle. The position of second trajectory 32 in the height direction is at a predetermined height from the ground. The positions of second right-side trajectory 32a and second left-side trajectory 32c in the vehicle width direction are located away from the respective side mirrors of the vehicle by a predetermined distance relative to the center of the vehicle.

Three-dimensional side face 33 has right-side three-dimensional trajectory 33a indicating a predicted traveling trajectory of the right side of the vehicle, backward three-dimensional trajectory 33b indicating a predicted traveling trajectory of the rear-end of the vehicle, and left-side three-dimensional trajectory 33c indicating a predicted traveling trajectory of the left side of the vehicle. Right-side three-dimensional trajectory 33a is indicated by an area surrounded by first right-side trajectory 31a, second right-side trajectory 32a and first separation line 34. Backward three-dimensional trajectory 33b is indicated by an area surrounded by first backward trajectory 31b, second backward trajectory 32b, first separation line 34 and second separation line 35. Left-side three-dimensional trajectory 33c is indicated by an area surrounded by first left-side trajectory 31c, second left-side trajectory 32c and second separation line 35.

As shown in FIG. 3, three-dimensional side face 33 is an image having color data. The density of color of three-dimensional side face 33 is gradually changed upward in the height direction. The color near first trajectory 31 is dark, and the color becomes lighter towards second trajectory 32. The rates of change in the density of color of right-side three-dimensional trajectory 33a, backward three-dimensional trajectory 33b and left-side three-dimensional trajectory 33c are the same. That is, the following rates of change in the density of color are the same: the rate of change in the density of color in the direction from first right-side trajectory 31a toward second right-side trajectory 32a, the rate of change in the density of color in the direction from first backward trajectory 31b toward second backward trajectory 32b; and the rate of change in the density of color in the direction from first left-side trajectory 31c toward second left-side trajectory 32c.

Since predicted traveling trajectory 30 is superimposed onto a taken image and is output to display device 12 by video processing device 3 in accordance with an instruction of control device 5, the user can intuitively grasp that right-side three-dimensional trajectory 33a, backward three-dimensional trajectory 33b and left-side three-dimensional trajectory 33c indicate a three-dimensional side face of three-dimensional predicted traveling trajectory 30.

Furthermore, the density of color of three-dimensional side face 33 is highest near first trajectory 31 and becomes gradually low toward second trajectory 32. Thus, the user can intuitively grasp the directionality from first trajectory 31 toward second trajectory 32. Therefore, the user can intuitively grasp that first trajectory 31 is a frame line on the ground and that second trajectory 32 is a frame line at a predetermined height from the ground. As a result of in-office questionnaire, the answer that first trajectory 31 is a frame line on the ground and second trajectory 32 is a frame line at a predetermined height from the ground can be obtained at the highest rate by increasing the density of color of three-dimensional side face 33 near first trajectory 31 of predicted traveling trajectory 30 and gradually reducing the density of color of three-dimensional side face 33 toward second trajectory 32.

In predicted traveling trajectory 30 of this embodiment, the color of three-dimensional side face 33 is the highest near first trajectory 31 and is gradually reduced toward second trajectory 32. However, the density of color of three-dimensional side face 33 only may be gradually reduced in any partial section in the height direction of three-dimensional side face 33. For example, it is also possible to keep the density of color of three-dimensional side face 33 unchanged from first trajectory 31 up to a predetermined height (½ of the height of three-dimensional side face 33 or lower) and to gradually increase the density of color of three-dimensional side face 33 toward second trajectory 32 from this predetermined height.

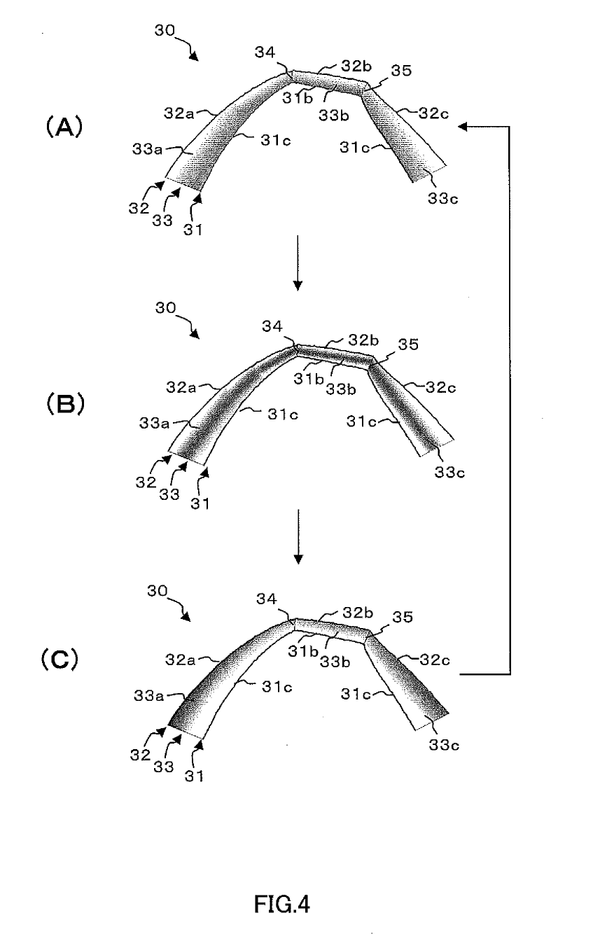

Control device 5 may cause video processing device 3 to change the density of color of predicted traveling trajectory 30 with time in FIG. 3. FIG. 4 is a graphical representation of change in the density of color of predicted traveling trajectory 30 with time in FIG. 3. As shown in FIG. 4, the change in the density of color of predicted traveling trajectory 30 with time starts from a state (A), transitions to a state (B) and then to a state (C), returns to the state (A) and repeats the state transition. Image data of predicted traveling trajectory 30 in each state is stored in nonvolatile memory 4.

As shown by the repetition of the states (A), (B) and (C) in FIG. 4, control device 5 causes video processing device 3 to superimpose predicted traveling trajectory 30 in which a part of three-dimensional side face 33 where the density of color is high is moved from first trajectory 31 side to second trajectory 32 side, onto a taken image at each predetermined time. Outputting this composite video to display device 12 by video processing device 3 in accordance with an instruction of control device 5 enables the user to intuitively grasp the directionality from first trajectory 31 toward second trajectory 32. That is, the user can intuitively grasp that first trajectory 31 is a frame line on the ground and that second trajectory 32 is a frame line at a predetermined height from the ground.

Control device 5 may control the speed of the change in the density of color of predicted traveling trajectory 30 with time on the basis of a vehicle speed signal input from vehicle speed sensor 9. For example, control device 5 increases the speed of the change in the density of color of predicted traveling trajectory 30 with time as the vehicle speed increases. Thereby, even if the vehicle speed increases, the user can intuitively grasp that first trajectory 31 is a frame line on the ground and that second trajectory 32 is a frame line at a predetermined height from the ground.

In this embodiment, nonvolatile memory 4 stores image data of predicted traveling trajectory 30 in the states (A), (B) and (C), control device 5 reads the image data of predicted traveling trajectory 30 in each state from nonvolatile memory 4 at each predetermined time interval, and video processing device 3 superimposes the image data of predicted traveling trajectory 30 onto a taken image. However, a different process may be performed. For example, it is also possible that nonvolatile memory 4 does not store the image data of predicted traveling trajectory 30 in each state, and control device 5 successively performs calculations and gives video processing device 3 an instruction for changing the density of color of predicted traveling trajectory 30. In this embodiment, the states (A), (B) and (C) are used as an example to describe the change in the density of color of predicted traveling trajectory 30 with time. However, more states may be used.

Control device 5 may further read other image data from nonvolatile memory 4 in addition to predicted traveling trajectory 30, and cause video processing device 3 to superimpose the image data onto a taken image.

Video processing device 3 may further superimpose other image data onto a taken image in addition to predicted traveling trajectory 30 on the basis of an instruction of control device 5.

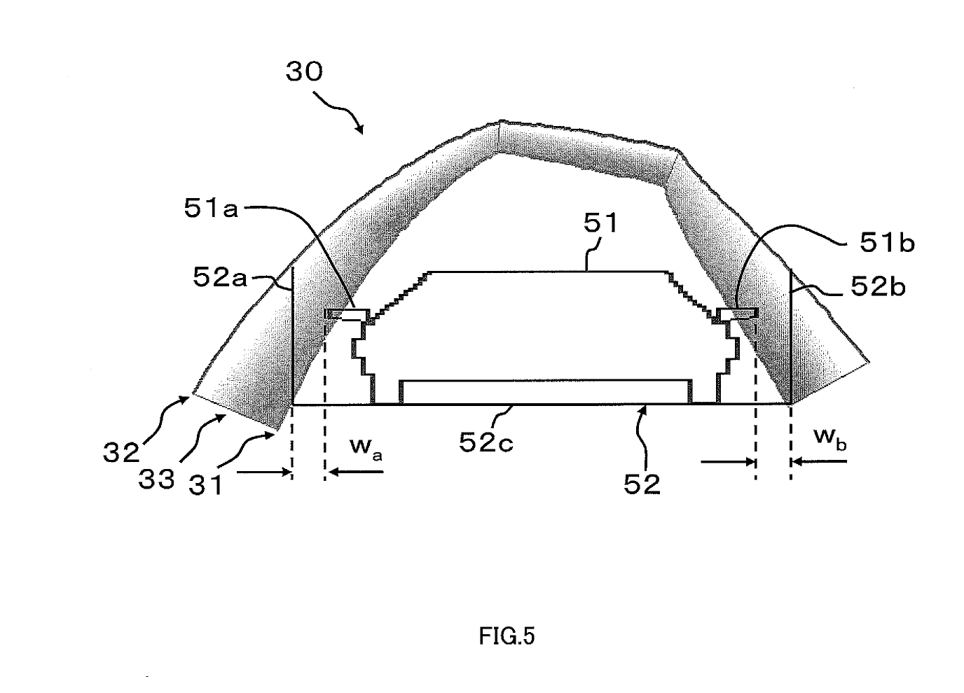

FIG. 5 is a diagram illustrating a representation of an image further superimposed on predicted traveling trajectory 30 in FIG. 3.

Control device 5 reads image-of-the-vehicle 51 and index line 52 in the width and height directions of the vehicle as shown in FIG. 5 from nonvolatile memory 4. Video processing device 3 superimposes predicted traveling trajectory 30, image-of-the-vehicle 51 and index line 52 input from nonvolatile memory 4 onto a taken image on the basis of an instruction of control device 5.

Image-of-the-vehicle 51 is a plane image when the vehicle is seen from the traveling direction, and has right side mirror image 51a and left side mirror image 51b. Index line 52 is formed in a square-bracket shape and includes right-side index line 52a, left-side index line 52b and ground index line 52c. Between the vehicle width direction end part of right side mirror image 51a and right-side index line 52a, predetermined interval wa is provided for safety. Similarly, between the vehicle width direction end part of left side mirror image 51b and left-side index line 52b, predetermined interval wb is provided for safety.

On the basis of an instruction of control device 5, video processing device 3 superimposes both of the intersection point between ground index line 52c and right-side index line 52a and the intersection point between ground index line 52c and left-side index line 52b onto first trajectory 31. The association between ground index line 52c located on the tire surfaces of image-of-the-vehicle 51 and first trajectory 31 by this positional relationship further enables the user to intuitively grasp that first trajectory 31 is a frame line on the ground and that second trajectory 32 is a frame line at a predetermined height from the ground.

Video processing device 3 may further superimpose other image data of image-of-the-vehicle 51 and index line 52 onto a taken image on the basis of an instruction of control device 5.

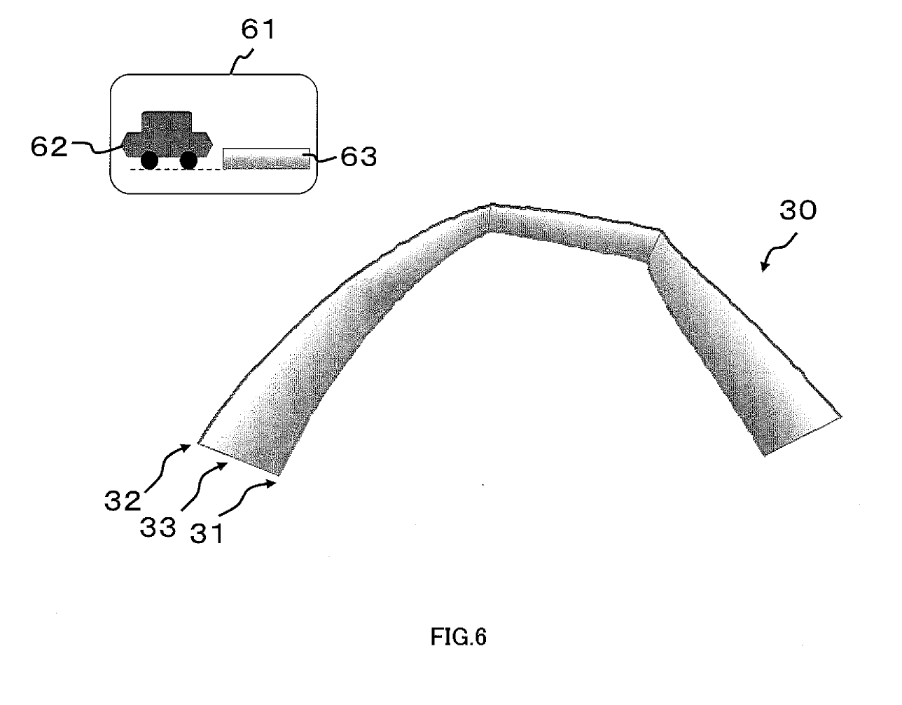

FIG. 6 is a diagram illustrating a representation of another example of the superimposed image in FIG. 5.

Control device 5 reads icon image 61 as shown in FIG. 6 from nonvolatile memory 4. Video processing device 3 superimposes predicted traveling trajectory 30 and viewpoint conversion image 61 input from nonvolatile memory 4 onto a taken image, on the basis of an instruction of control device 5.

Viewpoint conversion image 61 is an image when the vehicle and predicted traveling trajectory 30 are seen from the side face direction of the vehicle. Viewpoint conversion image 61 has viewpoint conversion image 62 of the vehicle image and viewpoint conversion image 63 of predicted traveling trajectory 30. From viewpoint conversion image 61 superimposed by video processing device 3, the user can know that first trajectory 31 on which the density of color of three-dimensional side face 33 is high is on the ground and that second trajectory 32 on which the density of color of three-dimensional side face 33 is low is at a predetermined height from the ground. Therefore, the user can grasp the situation further intuitively.

In this embodiment, nonvolatile memory 4 stores the image data of three-dimensional predicted traveling trajectory 30 of the vehicle in advance, and control device 5 reads the image data of predicted traveling trajectory 30 from nonvolatile memory 4. However, it is not necessary for nonvolatile memory 4 to have the image data of predicted traveling trajectory 30 in advance. In this case, control device 5 successively calculates predicted traveling trajectories on the basis of steering wheel angle signals from steering sensor 10.

Incidentally, three-dimensional side face 33 may have two or more colors. In this case, control device 5 performs control so that the density of a certain color is gradually reduced from first trajectory 31 toward second trajectory 32.

In this embodiment, first trajectory 31 includes first right-side trajectory 31a, first backward trajectory 31b and first left-side trajectory 31c. However, first trajectory 31 can be formed by at least first right-side trajectory 31a and first left-side trajectory 31c. Similarly, second trajectory 32 can be formed by at least second right-side trajectory 32a and second left-side trajectory 32c. In this case, three-dimensional side face 33 includes right-side three-dimensional trajectory 33a and left-side three-dimensional trajectory 33c.

The contents of disclosure of the specification, drawings and abstract included in Japanese Patent Application 2010-041858 filed on Feb. 26, 2010 are hereby incorporated by reference thereto in its entirety.

### INDUSTRIAL APPLICABILITY

The present invention is useful especially for intuitively grasping a three-dimensional predicted traveling trajectory displayed at the time of parking backward.

### REFERENCE SIGNS LIST

1 driving assistance apparatus
2 volatile memory
3 video processing device
4 nonvolatile memory
5 control device

1-3. (canceled)

4. A driving assistance apparatus comprising:
a video processing section that superimposes a three-dimensional predicted traveling trajectory of a vehicle onto a received taken image of the outside of the vehicle and outputs the taken image to an external display, the vehicle including the driving assistance apparatus; and
a control section that controls, on the basis of a received steering wheel angle of the vehicle, the orientation of the three-dimensional predicted traveling trajectory superimposed by the video processing section, wherein
the predicted traveling trajectory includes a first trajectory indicating a bottom face side of a three-dimensional body and a second trajectory indicating a top face side of the three-dimensional body, and a three-dimensional side face is formed by a space surrounded by the first trajectory and the second trajectory,
the first trajectory has at least a first right-side trajectory and a first left-side trajectory,
the second trajectory has at least a second right-side trajectory and a second left-side trajectory,
the control section causes the video processing section to gradually change the density of color of the three-dimensional side face of the predicted traveling trajectory upward in the height direction, and
the video processing section reduces the density of color from the first right-side trajectory toward the second right-side trajectory and from the first left-side trajectory to the second left-side trajectory.

5. The driving assistance apparatus according to claim 4, wherein the control section causes the video processing section to change the density of color of the three-dimensional side face of the predicted traveling trajectory upward in the height direction with time.
